(19) United States
(12) Patent Application Publication
(10) Pub. No.: US 2010/0006342 A1
(43) Pub. Date: Jan. 14, 2010

(54) METHOD OF MAKING WELLBORE MOINEAU DEVICES

(75) Inventors: Dirk Froehlich, Moore, OK (US); Thomas Jung, Eicklingen (DE); Fausto Catoni, Houston, TX (US)

Correspondence Address: Mossman, Kumar and Tyler, PC, 11200 Westheimer Road, Suite 900, Houston, TX, 77042, US

(73) Assignee: BAKER HUGHES INCORPORATED, Houston, TX (US)

(21) Appl. No.: 12/499,465

(22) Filed: Jul. 8, 2009

Related U.S. Application Data
(60) Provisional application No. 61/079,901, filed on Jul. 11, 2008.

(51) Int. Cl. E21B 4/02; H02K 15/02

(52) U.S. Cl. 175/107; 29/596

(57) ABSTRACT

A method of making a drilling motor for use in a wellbore includes defining a profile for an inner surface of a stator; configuring at least one cutting element on a support to at least partially form the profile; translating the support through a bore of the stator such that the at least one cutting element engages the inner surface of the stator; and forming a helical passage using the at least one cutting element by causing relative rotation between the stator and the support.

### CROSS-REFERENCE TO RELATED APPLICATIONS

This applications claims priority from U.S. Provisional Patent Application Ser. No. 61/079,901, filed Jul. 11, 2008.

### BACKGROUND OF THE DISCLOSURE

1. Field of the Disclosure

This disclosure relates generally to moineau motors and pumps used for drilling wellbores and more particularly to methods of making such devices.

2. Description of the Related Art

To obtain hydrocarbons such as oil and gas, boreholes or wellbores are drilled by rotating a drill bit attached to a drill string end. A substantial proportion of the current drilling activity involves directional drilling, i.e., drilling deviated and horizontal boreholes, to increase the hydrocarbon production and/or to withdraw additional hydrocarbons from the earth's formations. Modern directional drilling systems generally employ a drill string having a drill bit at the bottom that is rotated by a motor (commonly referred to in the oilfield as the “mud motor” or the “drilling motor”).

Positive displacement motors are commonly used as mud motors. A typical mud motor includes a power section which contains a stator and a rotor disposed in the stator. A stator typically includes a housing that is lined inside with a helically contoured or lobed elastomeric material. The rotor is usually made from a suitable metal, such as steel, and has an outer lobed surface. Pressurized drilling fluid is pumped into a progressive cavity formed between the rotor and stator lobes. The force of the pressurized fluid pumped into the cavity causes the rotor to turn in a planetary-type motion. A suitable shaft connected to the rotor via a flexible coupling compensates for eccentric movement of the rotor. The shaft is coupled to a bearing assembly having a drive shaft, which in turn rotates the drill bit attached thereto.

As noted above, both the rotor and stator are lobed. The rotor and stator lobe profiles are similar, with the rotor having one less lobe than the stator. The difference between the number of lobes on the stator and rotor results in an eccentricity between the axis of rotation of the rotor and the axis of the stator. The lobes and helix angles are designed such that the rotor and stator lobe pair seal at discrete intervals, which creates axial fluid chambers that are filled by the pressurized circulating fluid. The action of the pressurized circulating fluid causes the rotor to rotate and precess within the stator.

The present disclosure provides efficient and cost effective methods for making such motors and other similar devices.

### SUMMARY OF THE DISCLOSURE

In aspects, the present disclosure provides a method of making a moineau device for use in a wellbore. The moineau device may include a stator. The method may include: defining a profile for an inner surface of the stator; configuring at least one cutting element on a support to at least partially form the profile; translating the support through a bore of the stator such that the at least one cutting element engages the inner surface of the stator; and forming a passage using the at least one cutting element by causing relative rotation between the stator and the support. The profile may include at least one lobe and at least one passage or a plurality of lobes and associated passages. In aspects, the method may further include rotating the stator. The steps of the method may be repeated until the profile is formed. In embodiments, the method may include disposing a rotor having an outer contoured surface within the stator to form a motor or a pump.

In arrangements, the at least one cutting element may include an arcuate profile. The cutting element may include a single element or a plurality of cutting elements. The plurality of cutting elements may be circumferentially arrayed. In embodiments, the method may include at least partially forming the profile before translating the support through the bore of the stator. In aspects, the method may also include applying a secondary material on the inner surface of the stator housing.

Examples of the more important features of the disclosure thus have been summarized rather broadly in order that the detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

For detailed understanding of the present disclosure, reference should be made to the following detailed description of the embodiment, taken in conjunction with the accompanying drawings, in which like elements have been given like numerals and wherein:

FIGS. 1A and 1B show a longitudinal cross-section of a drilling motor;

FIG. 2 illustrates a sectional end view of a tubular and a cutting system according to one embodiment of the present disclosure;

FIG. 3 illustrates a profile of a stator made by using one illustrative method of the present disclosure; and

FIG. 4 illustrates a sectional view of a cutting element according to one embodiment of the present disclosure.

### DESCRIPTION OF THE DISCLOSURE

The present disclosure relates to methods for wellbore devices that utilize profiles that include passages and lobe-like features. For example, the wellbore devices may include moineau-type devices such as motors and pumps. The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein.

While the teachings of the present disclosure may be advantageously applied to various types of wellbore equipment, for simplicity, the present teaching will be described in connection with moineau devices that are commonly utilized during the drilling oilfield wellbores. Generally, a moineau motor generates rotational power in response to an applied pressure differential energizes and a moineau pump displaces fluid in response to an applied rotational power. While certain operating characteristics and configurations may vary between a pump and a motor, the present teachings may be advantageously applied to either device. For convenience, the term moineau devices encompass motors and pumps.

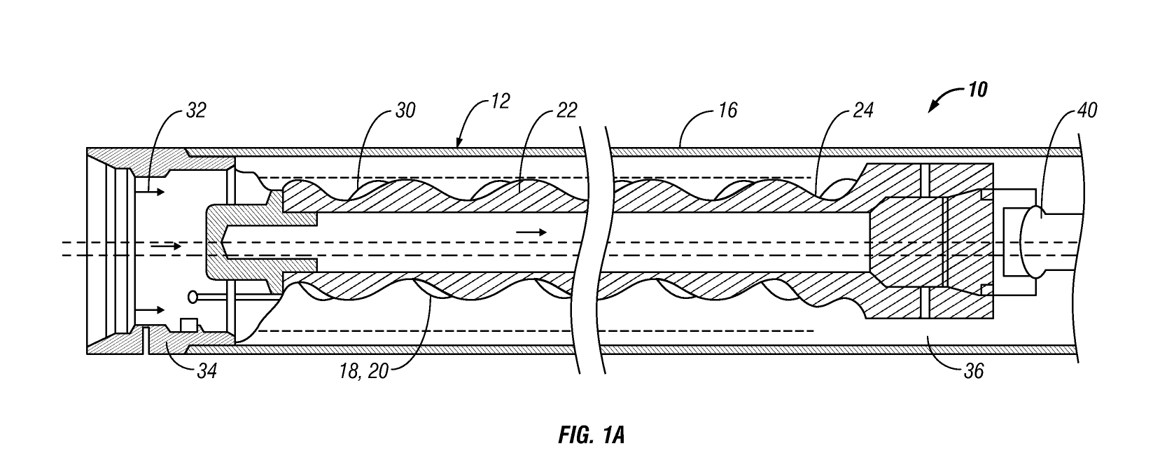

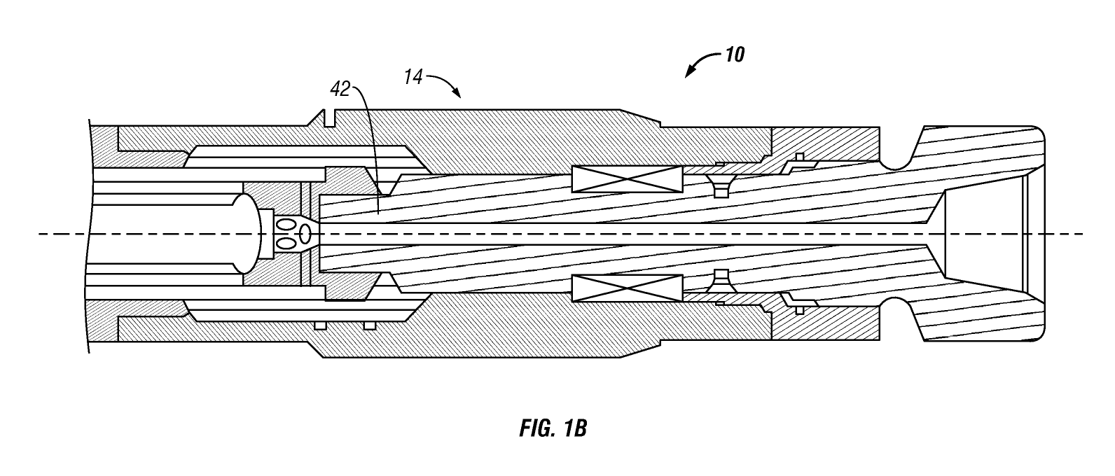

Referring initially to FIGS. 1A-1B, there is shown a cross-sectional view of a positive displacement motor 10 having a power section 12 and a bearing assembly 14. The power section 10 may contain a stator 16 that has a helically-lobed inner surface 18, which may include a lining, coating or protection member 20. The member 20 may be an elastomeric or metal lining, coating or layer configured to protect the inner surface 18 from corrosion, wear or other type of degradation.

The power section 10 may also include a rotor 22 that is configured to rotate inside the stator 16. The rotor 22 may have a helically-lobed outer surface 24 that has a profile that complements the profile of the helically-lobed inner surface 18 of the stator 16. The rotor 22 and the stator 16 may have a different number of lobes, e.g., the rotor may have one less lobe than the stator 16. The profiles of the stator inner surface 18 and the rotor outer surface 24 and their helical angles are such that the rotor 22 and the stator 16 seal at discrete intervals as the rotor 22 rotates eccentrically inside the stator 16. The sealing creates axial fluid chambers or cavities 30 that are filled by the pressurized drilling fluid 32. The fluid is displaced along the length of the motor 10 while in the cavities 30. The action of the pressurized circulating drilling mud 32 flowing from the top 34 to the bottom 36 of the power section 12 causes the rotor 22 to rotate within the stator 16. The rotor 22 may be coupled to a flexible shaft 40, which connects to a rotatable drive shaft 42 in the bearing assembly 14 that carries the drill bit (not shown).

As should be appreciated, the efficiency of the motor 10 depends, in part, on how accurately the constituent components of the motor 10 have been fabricated. As will become apparent, the manufacturing methodologies described herein that use, in part, cutting techniques may enable components, such as the stator 16, to be manufactured with relatively high-precision and using relatively low-tolerances. Because tighter tolerances may be achieved, the thicknesses of the protection layer 20, which may also be present on the outer surface of the rotor 22, may be reduced. This may be advantageous because such layers may be made thicker than otherwise necessary to accommodate components made to relatively large tolerances.

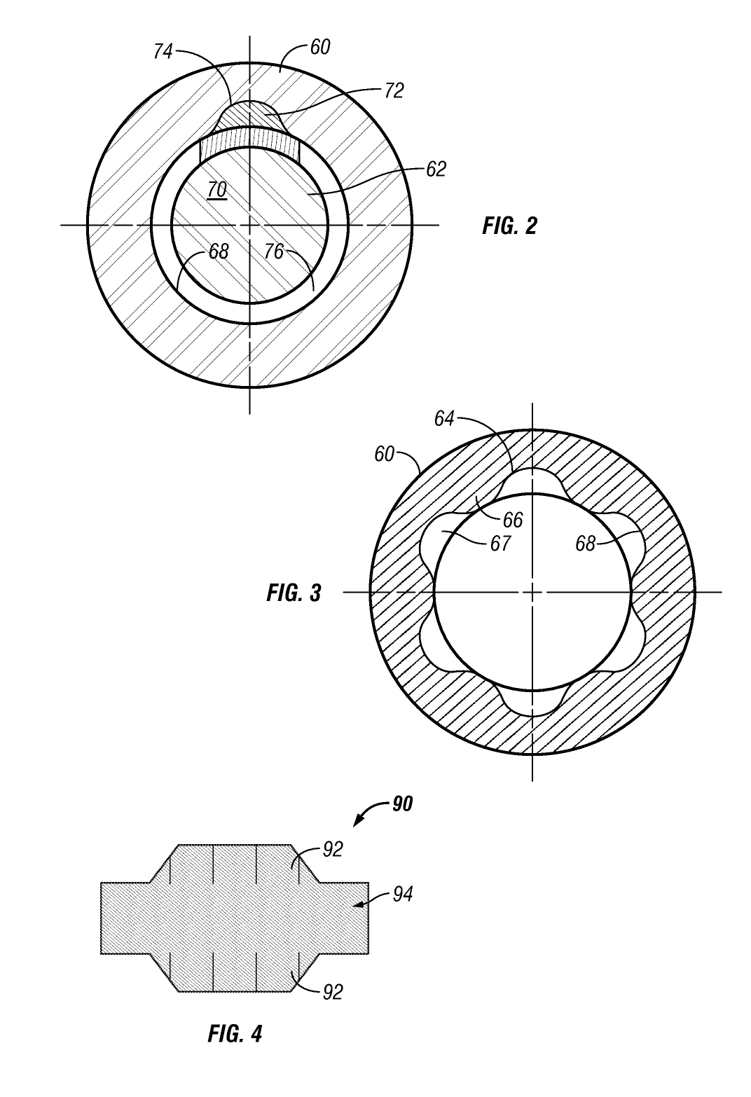

Referring now to FIGS. 2 and 3, there is shown a tubular 60 that may be formed into a stator, such as the stator 16 shown in FIG. 1A, by using a cutting device 62. The tubular 60 may be formed of a material such as a metal or other material that can be machined. The cutting device 62 may be used to form a profile 64 that includes a plurality of lobes 66 and a corresponding plurality of passages 67 on an inner surface 68 of the tubular 60. The profile 64 may typically have an even number of passages 67 and lobes 66, but may have an odd number in certain applications.

In one embodiment, the cutting device 62 may include a rigid support or mandrel 70 that includes a cutting element 72. The cutting element 72 may include an arcuate or curvilinear profile 74 that may be used to form the lobes 66. As used herein, a “profile” may be considered the shape of a feature as observed along a longitudinal axis of the tubular 60; e.g., the end view shown in FIG. 3. The cross-sectional shape (not shown) of the cutting element 72 may be triangular, rectangular, or any other geometric shape that is adapted for cutting into the stator 16.

The cutting device 62 may utilize any of a number of configurations. In one embodiment, a cutting device 62 may include a single cutting element 72. In another embodiment, a cutting device 62 may utilize two physically separate cutting elements 72 that have different dimensions, such as the radial distance. In other embodiments, a plurality of cutting elements 72 on a single body may be fixed on the support 70. The cutting elements may be successively radially stepped such that that each cutting element makes a progressively deeper cut into the inner surface 18 of the stator 16 than the preceding cutting element. For example, in embodiments, the plurality of cutting elements may include one or more leading cutting elements that perform a rough cut of the surface, one or more intermediate cutting elements that perform a semi-finishing cut on the surface, and one or more trailing cutting elements that perform a final finishing cut on the surface. The support 70 may be configured to translate along a long axis of the tubular 60 through a bore 76 of the tubular 60. The plurality of cutting elements may be helically or spirally configured on the support 70.

Referring now to FIG. 4, in embodiments, a cutting device 90 may utilize two or more circumferentially arrayed cutting elements 92 that are positioned on a support 94. In some embodiments, the cutting elements 92 are circumferentially equidistant to one another. Such an arrangement may be useful to center and stabilize the cutting device 90 as the cutting device 90 travels through the bore of the tubular 60.

Additionally, in embodiments, the support 70 and the tubular 60 rotate relative to one another as the cutting element 72 translates through the bore 76. In one arrangement, the support 70 is held rotationally stationary while the tubular 60 is rotated. For example, the tubular 60 may be secured an array of rollers that rotate the tubular 60. In another arrangement, the support 70 rotates while translating axially through the bore 76 of the tubular 60 as the tubular 60 is secured in a vise or other clamping device. In either case, it should be appreciated that the relative rotation movement causes the cutting element 72 to follow a helical track or path along the inner surface 18 of the stator 16. This cutting action ultimately forms the helical lobe profile 64 in the tubular 60. In some embodiments, the support 70 may include one or more cutting elements 72 that are configured to form a single passage 67. In such embodiments, the support 70 may be stabilized and guided using the inner surface 18. In other embodiments, the support 70 may includes two or more sets of cutting elements 72, each of which are configured to form a passage 67 as the support 70 translates through the bore 76.

In some embodiments, the tubular 60 may be machined to a semi-finished condition by using machining or metal working processes. That is, some or all of the lobes/passages may be machined to a semi-finished state. Other processes that may be used to pre-form the lobes/passages include contour honing, twist reaming, electro-chemical machining, electrical discharge machining and flow grinding. Thereafter, the cutting device 62 may be used to shape the lobes into their final form. In other embodiments, the cutting device 62 may be the only device used to form the lobes.

In an exemplary mode of manufacture, a tubular 60 is positioned and secured in a receiving device. The receiving device may include clamping mechanisms and may be configured to rotate the tubular 60. Next, a support 70 and cutting element 72 are inserted into a bore 76 of the tubular 60 and oriented as needed. Once appropriately positioned, the support 70 and the cutting element 72 may be driven axially through the bore 76. Concurrent with this axial movement, the tubular 60 may be rotated such that the cutting element 72 follows a helical track on the inner surface 68 of the tubular 60. Thus, the cutting element 72 forms the contours of a lobe 66 and a passage 67. The translation action associated with the cutting may be in one axial direction or both axial directions.

The cutting element 72 may be configured such that a single pass through the tubular 60 may fully form the passage 67. Thereafter, the cutting element 72 and the support 70 may be re-positioned and driven again through the tubular 60. The process may be repeated until the desired profile is obtained.

After the profile has been formed, the inner surface 68 of the tubular 60 may be coated or lined with any suitable material, including an elastomeric material, a thermoplastic material, a ceramic material, and a metallic material. Any suitable method or process may be utilized to apply such materials to the stator housing. The processes utilized may include a galvanic deposition process, (ii) an electrolytic deposition process, (iii) a molding process, (iv) a baking process, (v) a plasma spray process, and (vi) a thermo-set process. The process utilized will depend upon the type of the material selected. The rotor may also be lined with a suitable material or rotor and stator may have metal-to-metal contacting surfaces.

The stator 16 (FIG. 1A) may be formed using a single tubular 60 or a plurality of tubulars 60 that have been joined together. Once the stator 16 has been manufactured to a final condition, the rotor 22 may be inserted to form a motor/pump.

Thus, it should be appreciated that what has been described includes, in part, a method of making a moineau device for use in a wellbores formed in an earthen formation. The method may include defining a profile for an inner surface of a stator; configuring one or more cutting elements on a support or mandrel to at least partially form the profile; translating the support through a bore of the stator such that the cutting element(s) engage the inner surface of the stator; and forming a passage using the cutting element(s) by causing relative rotation between the stator and the support. The profile may include one or more lobes and associated passages. The method may also include rotating the stator or rotating the support. In embodiments, the method may include disposing a rotor having an outer contoured surface within the stator to form a motor or a pump.

The foregoing description is directed to a particular embodiment of the present disclosure for the purpose of illustration and explanation. It will be apparent, however, to one skilled in the art that many modifications and changes to the embodiment set forth above are possible without departing from the scope and the spirit of the disclosure. It is intended that the following claims be interpreted to embrace all such modifications and changes.

What is claimed is:

1. A method of making a moineau device for use in a wellbore, comprising:
(a) defining a profile for an inner surface of a stator, the profile include at least one lobe and at least one passage;
(b) configuring at least one cutting element on a support member to at least partially form the profile;
(c) translating the support member through a bore of the stator such that the at least one cutting element engages the inner surface of the stator; and
(d) forming a helical passage using the at least one cutting element by causing relative rotation between the stator and the support member.

2. The method of claim 1 further comprising rotating the stator.

3. The method of claim 1 wherein the profile includes a plurality of lobes.

4. The method of claim 1, wherein steps (b)-(d) are repeated until the profile is formed.

5. The method of claim 1, further comprising disposing a rotor having an outer contoured surface within the stator to form the moineau device.

6. The method of claim 1 wherein the at least one cutting element includes an arcuate profile.

7. The method of claim 1 wherein the at least one cutting element includes a plurality of cutting elements.

8. The method of claim 1 further comprising at least partially forming the profile before translating the support member through the bore of the stator.

9. The method of claim 1 further comprising applying on the inner surface of the stator housing a secondary material.

10. The method of claim 9 wherein the secondary material includes at least one of:
(i) elastomeric material, (il) a thermoplastic material, (iii) a ceramic material, and (iv) a metallic material.

11. A method of making a moineau device for use in a wellbore, the moineau device having at least a stator, the stator including an inner surface having a profile that includes at least one lobe and at least one passage, the method comprising:
shaping at least one cutting element to at least partially correspond with the profile;
engaging the inner surface of the stator with the at least one cutting element;
translating the at least one cutting element through a bore of a stator; and
rotating the stator relative to the cutting element to form a helical passage using the at least one cutting element.

12. The method of claim 11 further comprising rotating only the stator.

13. The method of claim 11 wherein the profile includes a plurality of lobes.

14. The method of claim 11, wherein the at least one cutting element is translated through the bore a plurality of times.

15. The method of claim 11, further comprising disposing a rotor having an outer contoured surface within the stator to form the moineau device.

16. An apparatus for use in a wellbore, comprising:
a stator having a bore defined by an inner surface, the inner surface having at least one lobe formed by translating at least one cutting element through the bore while rotating the stator relative to the at least one cutting element; and
a rotor disposed in the bore.

17. The apparatus of claim 16 wherein the stator includes a secondary material on the inner surface.

18. The apparatus of claim 16 wherein the secondary material includes at least one of: (i) elastomeric material, (il) a thermoplastic material, (iii) a ceramic material, and (iv) a metallic material.

19. The apparatus of claim 16 wherein the profile includes a plurality of lobes.

20. The apparatus of claim 16 wherein the at least one cutting element includes an arcuate profile.
